(19) United States
(12) Patent Application Publication
(10) Pub. No.: US 2015/0375648 A1
(43) Pub. Date: Dec. 31, 2015

(54) HEADREST FOR A VEHICLE, AND METHOD FOR PRODUCING SAME

(71) Applicant: JOHNSON CONTROLS TECHNOLOGY COMPANY, Holland, MI (US)

(72) Inventors: Daniel NAVARRO, Haguenau (FR); Sebastien GENTIL, Strasbourg (FR); Nathalie LANG, Wisches (FR)

(21) Appl. No.: 14/765,431

(22) PCT Filed: Feb. 5, 2014
(86) PCT No.: PCT/EP2014/052241

§ 371 Date: Aug. 3, 2015

(30) Foreign Application Priority Data
Feb. 5, 2013 (DE) 10 2013 201 813.4

(51) Int. Cl. B60N 2/48; B29C 44/12

(52) U.S. Cl. CPC B60N 2/48; B29C 44/1266; B29L 2031/3023

(57) ABSTRACT

A headrest (1) for a vehicle includes a headrest body (2), a headrest mounting (3), and an outer face fitting (4). A connecting part (5), within the headrest body (2) connects the headrest mounting (3) to the headrest body (2). The connecting part (5) is made of a first foam material produced within the fitting (4) in a pour-in-place method. A support element (8), which is made of a second foam material, is arranged on an inner face of the fitting (4) in a supporting region (SB), which is provided for supporting the head of a passenger, between the connecting part (5) and the fitting (4). The first foam material has a greater strength, in particular a greater compressive strength, and a greater indentation hardness than the second foam material. A method for producing a headrest (1) for a vehicle is also provided.

### CROSS REFERENCE TO RELATED APPLICATIONS

This application is a United States National Phase Application of International Application PCT/EP2014/052241 filed Feb. 5, 2014 and claims the benefit of priority under 35 U.S.C. §119 of German Patent Application 10 2013 201 813.4 filed Feb. 5, 2013 the entire contents of which are incorporated herein by reference.

### FIELD OF THE INVENTION

The invention relates to a headrest for a vehicle, having a headrest body, a headrest holder and a cover provided on an outer side of the headrest body, wherein a connecting part for connecting the headrest holder to the headrest body is provided within the headrest body.

### BACKGROUND OF THE INVENTION

The invention also relates to a method for producing a headrest for a vehicle, having a headrest body, a headrest holder and a cover provided on an outer side of the headrest body, wherein a connecting part for connecting the headrest holder to the headrest body is arranged within the headrest body.

Headrests for vehicles, in which a filling material in the form of a foam is arranged between an outer cover and an inner connecting part for attaching the headrest to a headrest holder, are well known from the prior art. In known headrests, provision is made for example for a preformed foaming body to be used to fill the headrest body.

DE 10 2005 015 292 B3 discloses such a headrest for a vehicle. The headrest comprises a headrest body and a headrest holder, wherein a cover is provided on the outer side of the headrest body. Provided within the headrest body is a connecting part for connecting the headrest holder to the headrest body, wherein a filling material formed from foam is arranged between the connecting part and the cover. The filling material is in a liquid form in its processing state, wherein the connecting part and the cover define a substantially impermeable spatial region with respect to the filling material in its processing state. Also described is a method for producing the headrest.

FR 2 890 890 A1 also describes such a headrest for a vehicle, wherein a cushioning element formed from a synthetic foam is arranged between a connecting part arranged within a headrest body and a cover arranged on the outer side of the headrest body.

DE 197 02 995 A1 discloses an energy-absorbing molded body which is intended to be used in headrests in motor vehicles, said molded body consisting of two foam layers having different densities and different elastic deformabilities. The two foam layers are arranged one behind the other in the direction of force application.

DE 30 22 551 A1 describes a headrest for a motor vehicle, said headrest consisting of a foam body comprising a metal fastening insert. The foam body consists of two separately manufactured, annular parts which consist of different materials with different indentation hardnesses.

### SUMMARY OF THE INVENTION

The present invention is based on an object of specifying a headrest for a vehicle, said headrest being improved with respect to the prior art, and an improved method for producing such a headrest.

The headrest for a vehicle comprises a headrest body, a headrest holder and a cover provided on an outer side of the headrest body, wherein a connecting part for connecting the headrest holder to the headrest body is provided within the headrest body.

According to the invention, the connecting part is formed from a first foam material produced within the cover by an “in-situ foaming method” or “pour-in-place method”, wherein a supporting element, which is formed from a second foam material, is fastened to an inner side of the cover in a supporting region, intended to support a passenger's head, between the connecting part and the cover. In one possible embodiment, the first foam material has higher strength and/or hardness, in particular higher compressive strength and/or compressive hardness and higher indentation hardness, than the second foam material.

On account of the connecting part being configured as a foam element, the headrest according to the invention is distinguished in a particularly advantageous manner by a low mass together with high mechanical stability and a particularly good restraining action for the passenger's head. In this case, the connecting part is producible in a particularly easy and cost-effective manner within the cover. On account of the high mechanical stability, it is also possible for the headrest to be producible with a smaller thickness and thus with an additionally reduced mass compared with headrests known from the prior art. The formation of the first foam material in an “in-situ foaming method” or “pour-in-place method” allows particularly rapid production of the connecting part in few working steps and with little effort.

According to one possible configuration, at least one molded foam element, which is formed from the second foam material, is arranged on an inner side of the cover in at least one further region between the connecting part and the cover. Thus, it is possible, in a particularly advantageous manner, for the headrest to be distinguished by a complex external shape, together with a soft feel.

In another possible configuration, the at least one molded foam element comprises the supporting element. In this embodiment, the headrest is distinguished by a particularly small number of individual parts and is very easy to produce.

In one development of the invention, the first foam material is a rigid or semirigid hard foam, in particular a polyurethane hard foam having a compressive strength of 0.1 MPa to 0.5 MPa (in particular measured to DIN EN 826 or some other comparable method with a compressive strength at 10% compression). The second foam material is for example a softer polyurethane foam made of a suitable polyol material and isocyanate material having a compressive hardness of 1 kPa to 15 kPa, in particular a polyurethane elastomer foam or a polyester or polyether foam. Alternatively, the second foam material can be a suitable cellular plastics material.

Headrests which are known from the prior art and have a prefabricated connecting part that is subsequently encapsulated by foam, have, by contrast, a greater mass, less mechanical stability and consequently less of a restraining action. Such headrests are also only producible with comparatively great effort compared with the solution according to the invention, since not only does the cover have to have an opening corresponding to the prefabricated connecting part for the introduction thereof but also an arrangement and orientation of the connecting part within the headrest body is realizable only with difficulty.

By contrast, these drawbacks are overcome by the creation of the connecting part within the cover in a foaming method. In particular, the connecting part can be configured to be as large as possible within the cover. Thus, optimal positioning of the connecting part and, on account of the reduction in the size of the opening, reduced effort and expenditure for closing said opening are achieved. A zipper known from the prior art can be dispensed with. The connecting part formed from the first foam material is also distinguished by improved force absorption properties. Furthermore, the large connecting part allows a simple geometry of the headrest holder and the bars thereof. In particular, the bars of the headrest holder can be configured in a shorter and lighter manner.

In this case, the first foam material can be formed at least in part from recycled material in a particularly advantageous and resource-saving manner.

On account of the connecting part being formed from the first foam material with the high hardness, such as high compressive hardness and indentation hardness, particularly precise shaping, adapted to the cover, and also particularly good long-term dimensional stability of the headrest body are achieved, this being particularly advantageous in particular when the cover is in the form of a leather cover.

According to one advantageous configuration, a coating which is impermeable with respect to the first foam material is arranged on the inner side of the cover, said coating sealing off the cover of the headrest with respect to the leaking out of the first foam material during the creation thereof within the cover.

In one development, the supporting element has a plurality of layers that extend substantially parallel to one another and to the supporting region. By adapting the number of layers, adaptation of the properties of the supporting element by setting the thickness thereof and thus setting of the mechanical resistance are realizable in a simple manner.

In order, in particular in the event of a collision of the vehicle, to ensure an optimized supporting action for the passenger's head, optimized impressing of the passenger's head into the supporting element and reduced displacement of the passenger's head away from the supporting element, the layers of the supporting element have different hardnesses, in particular compressive hardnesses and indentation hardnesses, according to a further configuration. In particular, the compressive hardnesses and indentation hardnesses increase from the inner side of the cover in the direction of the inside of the headrest body.

Furthermore, the first foam material has in particular a density of 25 kg/m³ to 50 kg/m³, this resulting in a particularly low mass of the connecting part and thus of the headrest.

In a method for producing a headrest for a vehicle, having a headrest body, a headrest holder and a cover provided on an outer side of the headrest body, a connecting part for connecting the headrest holder to the headrest body is arranged within the headrest body.

According to the invention, the connecting part is formed from a first foam material produced by an “in-situ foaming method” or “pour-in-place method” within the cover, wherein, before the connecting part is created, a supporting element, which is formed from a second foam material, is fastened to an inner side of the cover in a supporting region, intended to support a passenger's head, between the connecting part and the cover. According to one development, the first foam material has a higher hardness, such as a higher compressive hardness and a higher indentation hardness, than the second foam material.

In a particularly advantageous manner, the method according to the invention allows easy and cost-effective production of the headrest, which, on account of the configuration of the connecting part as a foam element, is distinguished by a particularly low mass together with high mechanical stability and a particularly good restraining action for the passenger's head.

The simplification and reduction in the costs results in particular from the production of the connecting part in the “in-situ foaming method” or “pour-in-place method” within the cover. Here, optimal position of the connecting part within the headrest body is also achieved.

On account of the high mechanical stability, it is possible for the headrest to be produced with a smaller thickness and thus with an additionally reduced mass compared with headrests known from the prior art.

In this case, the method according to the invention is implementable in a particularly advantageous manner with devices, already known from the prior art, for filling headrest bodies with foam, and so no investment costs, or at least only low investment costs, are necessary in order to realize the method according to the invention.

In one development of the method, at least one molded foam element, which is formed from the second foam material, is arranged on an inner side of the cover in at least one further region between the connecting part and the cover. Thus, it is possible, in a particularly advantageous and simple manner, for the headrest to be produced such that it is distinguished by a complex external shape, together with a soft feel.

In order to seal off the cover of the headrest with respect to the leaking out of the first foam material during the creation thereof within the cover, according to an advantageous configuration a coating which is impermeable with respect to the first foam material is arranged on the inner side of the cover.

In one development, the supporting element is formed from a plurality of layers that extend substantially parallel to one another and to the supporting region. By adapting the number of layers, adaptation of the properties of the supporting element by setting the thickness thereof and thus setting of the mechanical resistance are realized in a simple manner.

Exemplary embodiments of the invention are explained in more detail in the following text with reference to drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic sectional illustration of a first exemplary embodiment of a headrest according to the prior art;

FIG. 2 is a schematic sectional illustration of a second exemplary embodiment of a headrest according to the prior art;

FIG. 3 is a schematic perspective partial sectional illustration of the headrest according to the prior art according to FIG. 2;

FIG. 4 is a schematically sectional illustration of a third exemplary embodiment of a headrest according to the prior art;

FIG. 5 is a schematic perspective illustration of a first exemplary embodiment of a headrest according to the invention;

FIG. 6 is a schematic sectional illustration of a second exemplary embodiment of the headrest according to the invention;

FIG. 7 is a schematic sectional illustration of a third exemplary embodiment of the headrest according to the invention;

FIG. 8 is a schematic perspective illustration of a cover of a headrest according to the invention;

FIG. 9 is a schematic sectional illustration of a fourth exemplary embodiment of the headrest according to the invention; and

FIG. 10 is a schematic plan view of an underside of the headrest according to FIG. 9.

### DESCRIPTION OF THE PREFERRED EMBODIMENTS

Mutually corresponding parts are provided with the same reference signs in all the Figures.

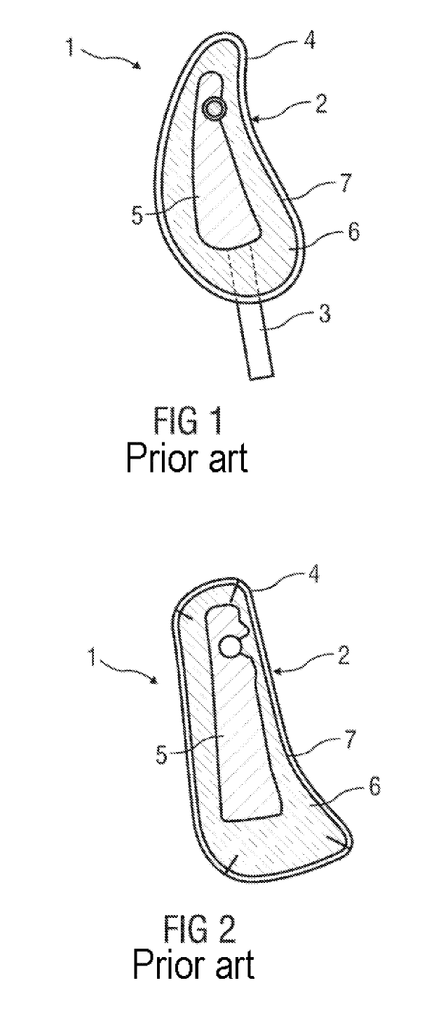

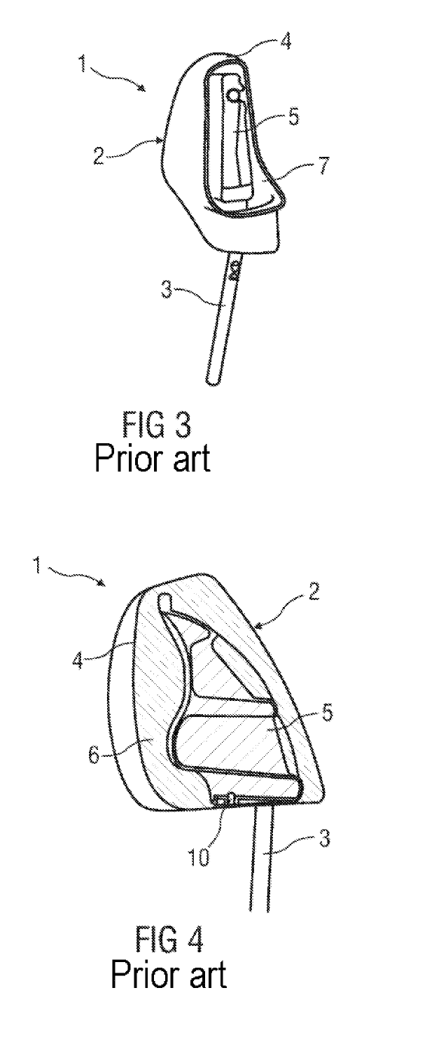

FIGS. 1 to 4 illustrate different views of three exemplary embodiments of a headrest 1 according to the prior art for a vehicle (not shown).

The headrest 1 comprises a headrest body 2, a headrest holder 3, formed from a metallic round bar, for fastening the headrest 1 to a backrest of a vehicle seat (not shown). Provided on the outer side of the headrest body 2 is a cover 4 within which a connecting part 5, formed from expanded polypropylene or some other plastics material, for connecting the headrest holder 3 to the headrest body 2 is arranged. An interior space, bounded by the cover 4 and the connecting part 5, of the headrest body 2 is surrounded by a foam body 6 which is formed from a soft foam material having a low compressive hardness and low indentation hardness.

In order to produce the headrest 1, the connecting part 5 is guided, together with the headrest holder 3, through an opening (not illustrated in more detail) in the cover 4 and is arranged and oriented within the latter.

Subsequently, the opening is closed in a suitable manner and the interior space is filled with a foam material, in a substantially liquid form, in what is referred to as an “in-situ foaming method” or “pour-in-place method”, said foam material forming the shape of the headrest body 2 by hardening, and fixing the connecting part 5 within the headrest body 2. The foam material introduced in a substantially liquid form is hard after 20 s in this case.

In order to seal off the cover 4 with respect to the leaking out of the liquid foam material, said cover has a coating 7 which is impermeable with respect to the foam material on its inner side.

In the third exemplary embodiment, illustrated in FIG. 4, of the headrest according to the prior art, the cover 4 comprises a plurality of retaining elements 10, formed from plastics material, for fastening the cover 4 to the connecting element 5.

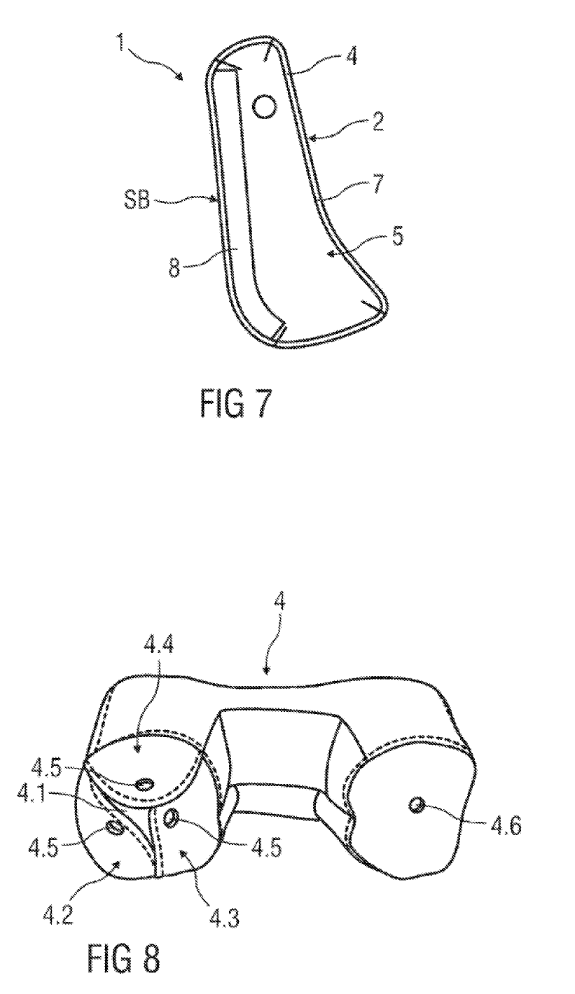

FIGS. 5 to 7 illustrate different views of various exemplary embodiments of a headrest 1 according to the invention.

In contrast to the headrest 1 according to the prior art, which is illustrated in FIGS. 1 to 4, the connecting part 5 is formed from a rigid or semirigid first foam material produced within the cover 4, said first foam material having a high compressive strength and/or hardness, in particular a high compressive hardness and a high indentation hardness. In this case, the first foam material has at most a density of 25 kg/m³ to 50 kg/m³ and is distinguished as a result by a particularly low mass together with high mechanical stability. For example, the first foam material is a polyurethane foam, in particular a hard polyurethane foam having a compressive strength of 0.1 MPa to 0.5 MPa (in particular measured to DIN EN 826 or some other comparable method with a compressive strength at 10% compression).

Furthermore, in contrast to the headrest 1 according to the prior art, which is illustrated in FIGS. 1 to 4, a supporting element 8 is arranged on an inner side of the cover 4 in a supporting region SB, intended to support a passenger's head, between the connecting part 5 and the cover 4. This supporting element 8 is formed from a soft second foam material which has a lower compressive strength and/or hardness, such as a lower compressive hardness and a lower indentation hardness, than the first foam material. The second foam material is for example a softer polyurethane foam made of a suitable polyol material and isocyanate material having a compressive hardness of 1 kPa to 15 kPa, in particular a polyurethane elastomer foam, or a polyester or polyether foam. Alternatively, the second foam material can be a suitable cellular plastics material.

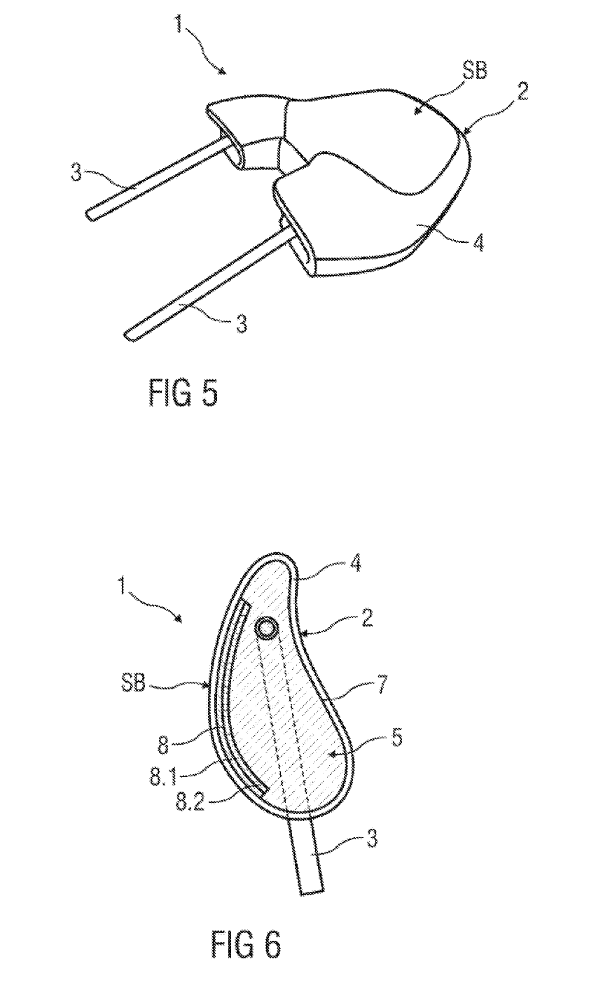

In this case, the supporting element 8 according to the embodiment illustrated in FIG. 6 has two layers 8.1, 8.2 that extend substantially parallel to one another and to the supporting region SB and which are distinguished by different hardnesses, such as compressive hardnesses and indentation hardnesses. In particular, in this case the first layer 8.1 has a lower compressive strength and/or hardness, such as a lower compressive hardness and indentation hardness, than the second layer 8.2. This means that the compressive hardness and indentation hardness of the layers 8.1, 8.2 increase from the inner side of the cover 4 in the direction of the interior of the headrest body 2. As a result, this allows the passenger to rest his head in a comfortable manner and also, in the event of a collision of the vehicle, ensures an optimized supporting action, optimized impressing of the passenger's head into the supporting element and reduced displacement of the passenger's head away from the supporting element. In the case of such an impact of the passenger's head, real absorption of the forces that occur can be achieved in a particularly advantageous manner on account of plastic deformation of the structure of the connecting part 5 formed from the first foam material, which is not mechanically flexible or mechanically flexible only to a minor extent.

In order to produce the headrest 1 according to the invention, first of all the supporting element 8 is arranged on the inner side of the cover 4, in particular fastened thereto. Fastening takes place in this case in a force-fitting, cohesive and/or form-fitting manner, in particular by adhesive bonding, sewing and/or by a touch-and-close connection to the inner side of the cover 4.

Subsequently, the headrest holder 3, in particular two bars, is arranged within the cover 4 and oriented before the interior space is completely filled with the first foam material, in a substantially liquid form, in an “in-situ foaming method” or “pour-in-place method”. The first foam material forms the connecting part 5 and substantially the shape of the headrest body 2 by hardening. In an alternative exemplary embodiment, the cover 4 is filled with foam prior to the arrangement of the headrest holder 3. To this end, space holders corresponding to the headrest holder 3 are preferably arranged within the cover 4 prior to the filling with foam.

In order to seal off the cover 4 with respect to the leaking out of the liquid first foam material, said cover 4 has a coating 7 that is impermeable with respect to the foam material on its inner side.

FIG. 8 shows a possible exemplary embodiment of the cover 4 for the headrest 1 according to the invention.

In this case, the cover 4 has a first opening 4.1 which is intended for turning the outer side of the cover 4 outward following the application of the coating 7 and the supporting element 8 to the inner side. After turning, the opening 4.1 is closed by a force-fitting, cohesive and/or form-fitting connection, in particular by adhesive bonding, sewing and/or by a touch-and-close connection of three at least partially overlapping portions 4.2 to 4.4 of the cover 4.

Furthermore, the cover 4 has two openings 4.5, 4.6 for passing through the headrest holder 3. In order to realize the opening 4.5, each of the portions 4.2 to 4.4 has an opening 4.5, wherein said openings 4.5 are arranged above one another without an offset. The openings 4.5, 4.6 are used to introduce the first foam material during the filling with foam.

Alternatively, the first foam material is introduced into the interior of the cover 4 through the opening 4.1 prior to the closure thereof.

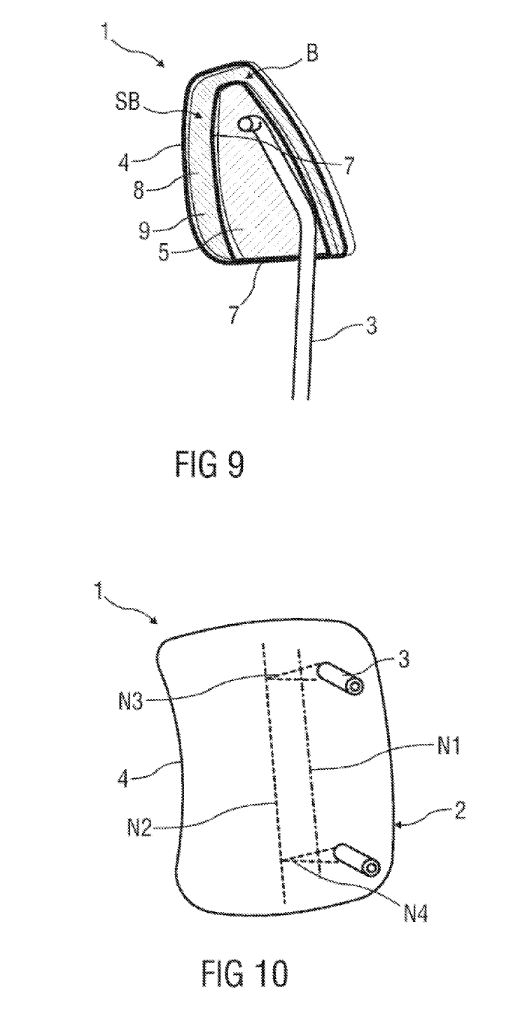

FIG. 9 illustrates a sectional illustration of a fourth exemplary embodiment of the headrest 1 according to the invention.

In contrast to the exemplary embodiments illustrated in FIGS. 5 to 7, at least one molded foam element 9 formed from the second foam material is arranged on an inner side of the cover 4 in at least one further region B, completely surrounding the connecting part 5, between the latter and the cover 4. The molded foam element 9 in this case comprises the supporting element 8 in the supporting region SB of the headrest 1. In other words, the supporting element 8 and the molded foam element 9 form a homogeneous molding.

In order to produce the headrest 1 in the exemplary embodiment illustrated, the molded foam element 9 is arranged within the cover 4. Subsequently, the headrest holder 3, which is configured in a U-shaped manner in the exemplary embodiment illustrated, is arranged and oriented before the interior space of the molded foam element 9 is completely filled with the first foam material, in a substantially liquid form, in an “in-situ foaming method” or “pour-in-place method”, in other words in situ. The first foam material forms the connecting part 5, which has the shape of the interior space of the molded foam element 9, by hardening.

In an alternative exemplary embodiment, the filling of the molded foam element 9 with foam takes place prior to the arrangement of the headrest holder 3. To this end, space holders that correspond to the headrest holder 3 are preferably arranged within the cover 4 prior to the filling with foam.

In order to seal off the molded foam element 9 with respect to the leaking out of the liquid foam material, said molded foam element 9 has a coating 7 that is impermeable with respect to the first foam material on its inner side. The cover 4 likewise has this coating 7 in the region of the interior space of the molded foam element 9.

FIG. 10 shows a plan view of an underside of the headrest 1 according to FIG. 9.

By way of this illustration, the advantages compared with the headrests known from the prior art are clarified.

In particular, no foam material is visible on the underside, since the cover 4 is completely closable. Furthermore, on account of its complete closure, the cover 4 is configured in a very simple manner. In particular, on account of the production of the connecting part 5 in the “in-situ foaming method” or “pour-in-place method”, in other words in situ, within the cover 4, no retaining elements 10 are required. In addition, a closure of the cover 4, on account of the production, carried out following the closure, of the connecting part 5 within the cover 4 and thus on account of the ommission of the subsequent introduction of the connecting part 5 into the cover 4, is possible with only one seam N1, whereas a plurality of seams N2 to N4 are required according to the prior art. Apart from the underside, the entire cover 4 can be configured in a closed manner.

Furthermore, as a result of the shaping, adapted precisely to the cover 4, particularly good long-term dimensional stability of the headrest body 2 is achieved, this being particularly advantageous in particular when the cover 4 is configured as a leather cover.

Furthermore, on account of the material selection and the configuration of the connecting part 5 from the first foam material in the “in-situ foaming method” or “pour-in-place method”, a particularly low weight of the headrest can be achieved.

In the fourth exemplary embodiment illustrated, in particular the arrangement and orientation of the supporting element 8 are very simple, since said supporting element 8 forms a molding with the molded foam element 9.

Furthermore, the quantity of waste during production is greatly reduced compared with the prior art, in particular on account of the fact that the cover can be formed in a substantially fold-free manner and is largely already closed before the production of the connecting part 5. A cost reduction can furthermore be achieved as a result.

Furthermore, impressions on the components of the headrest 1, which can occur for example during the introduction of the connecting part 5 according to the prior art, are also avoided.

While specific embodiments of the invention have been shown and described in detail to illustrate the application of the principles of the invention, it will be understood that the invention may be embodied otherwise without departing from such principles.

1. A headrest for a vehicle, the headrest comprising:
a headrest body;
a headrest holder; and
a cover provided on an outer side of the headrest body, wherein the headrest body comprises a connecting part for connecting the headrest holder to the headrest body within the headrest body wherein the connecting part is formed from a first foam material produced within the cover by an in-situ foaming method or a pour-in-place method, wherein the headrest body further comprises a supporting element, which is formed from a second foam material and is arranged on an inner side of the cover in a supporting region, intended to support a passenger's head, between the connecting part and the cover.

2. The headrest as claimed in claim 1, wherein the headrest body further comprises at least one molded foam element, which is formed from the second foam material arranged on an inner side of the cover in at least one further region between the connecting part and the cover.

3. The headrest as claimed in claim 2, wherein the at least one molded foam element is a homogeneous molding with the supporting element.

4. The headrest as claimed in claim 1, wherein the first foam material has a higher compressive hardness and a higher indentation hardness, than the second foam material.

5. The headrest as claimed in claim 1, further comprising a coating, which is impermeable with respect to the first foam material, is arranged on an inner side of the cover.

6. The headrest as claimed in claim 1, wherein the supporting element has a plurality of layers that extend substantially parallel to one another and to the supporting region.

7. The headrest as claimed in claim 6, wherein the layers have different compressive hardnesses and indentation hardnesses.

8. The headrest as claimed in claim 1, wherein the first foam material has a density of 25 kg/m³ to 50 kg/m³.

9. A method for producing a headrest for a vehicle, having a headrest body, a headrest holder and a cover provided on an outer side of the headrest body, wherein the headrest body comprises a connecting part for connecting the headrest holder to the headrest body and is arranged within the headrest body, the method comprising the steps of:
forming the connecting part from a first foam material produced by an in-situ foaming method or a pour-in-place method within the cover,
forming, before the connecting part is created, a supporting element from a second foam material, with the supporting element being arranged on an inner side of the cover in a supporting region, intended to support a passenger's head, between the connecting part and the cover.

10. The method as claimed in claim 9, wherein at least one molded foam element, which is formed from the second foam material, is arranged on an inner side of the cover in at least one further region between the connecting part and the cover.

11. The method as claimed in claim 9, wherein a coating which is impermeable with respect to the first foam material is arranged on the inner side of the cover.

12. The method as claimed in claim 9, wherein the supporting element is formed from a plurality of layers that extend substantially parallel to one another and to the supporting region.

13. The method as claimed in claim 10, wherein a coating which is impermeable with respect to the first foam material is arranged on the inner side of the cover.

14. The method as claimed in claim 10, wherein the supporting element is formed from a plurality of layers that extend substantially parallel to one another and to the supporting region.

15. The method as claimed in claim 11, wherein the supporting element is formed from a plurality of layers that extend substantially parallel to one another and to the supporting region.
